(19) United States
(12) Patent Application Publication
(10) Pub. No.: US 2013/0210366 A1
(43) Pub. Date: Aug. 15, 2013

(54) ANTENNA ARRANGEMENT FOR VEHICLES FOR TRANSMITTING AND RECEIVING

(71) Applicants: Thomas Hansen, Hildesheim (DE); Frank Hofmann, Hildesheim (DE)

(72) Inventors: Thomas Hansen, Hildesheim (DE); Frank Hofmann, Hildesheim (DE)

(73) Assignee: Robert Bosch GmbH, Stuttgart (DE)

(21) Appl. No.: 13/639,532

(22) PCT Filed: Feb. 21, 2011
(86) PCT No.: PCT/EP2011/052480

§ 371 Date: Dec. 18, 2012

(30) Foreign Application Priority Data
Apr. 6, 2010 (DE) 10 2010 003 646.3

(51) Int. Cl. H01Q 21/29; H04B 7/04

(52) U.S. Cl. CPC H01Q 21/29; H04B 7/0404
USPC 455/63.4; 343/893; 343/713

(57) ABSTRACT

An antenna arrangement for vehicle-to-vehicle communication includes at least two antenna transmitters each having a unidirectional directional diagram. The antenna transmitters are positioned in such a manner that a combination of the unidirectional directional diagrams of the antenna transmitters generates a largely omnidirectional directional diagram by way of a method for transmitting and/or receiving.

### PRIOR ART

The invention is based on an antenna arrangement for a vehicle for transmitting and receiving according to the generic type of the independent claims.

From DE10209060A1, an antenna arrangement for a vehicle for receiving for the GHz frequency band is known. The antenna arrangement uses receive diversity for reducing the probability of interference.

Diversity systems, multiple-input-multiple-output systems and orthogonal frequency division multiplexing are known, for example, from Zhang et al., Future Transmitter/Receiver Diversity Schemes in Broadcast Wireless Networks, IEEE Communications Magazine 2008. Diversity systems use two or more antennas for improving quality and reliability of a radio link. In the case of delayed diversity, the same signal is radiated simultaneously at the transmitting end by at least two antennas, but with a delay in each case. In the case of switching diversity, only one antenna is in each case selected at the receiving end. Maximum ratio combining combines the signals in the receiver of individual transmission channels by means of a selected criterion. Multiple-input-multiple-output designates the use of a number of antennas at the transmitter and receiver end in order to improve the quality of the transmission, and increase the transmission data rate.

### DISCLOSURE OF THE INVENTION

In contrast, an antenna arrangement according to the invention having the features of the independent claim 1 has the advantage that it can both transmit and receive with at least two antenna radiators in an almost omnidirectional range around a vehicle. This is achieved by means of a method for transmitting and/or receiving. In this context, the patterns of an antenna radiator may be only unidirectional. Omnidirectional reception and omnidirectional transmitting improves the reliability of the radio link between vehicles and thus reduces the packet error rate.

The features listed in the dependent claims provide for advantageous developments and improvement of the antenna arrangement specified in the independent claim.

The use of antenna radiators for a frequency between 0.5 GHz and 11 GHz is particularly advantageous since this frequency band has been released for mobile radio and an established data transmission therefore exists. Transmitting and receiving at a frequency, of, for example 5.9 GHz is of importance to radio communication between vehicles since the ETSI standard provides this frequency so that vehicles can set an ad-hoc network and exchange information such as, for example, position, speed or warning messages.

The use of a diversity method or multiple-input-multiple-output method for transmitting and/or receiving is suitable for improving the radio transmission.

The use of delay diversity or cyclic delay diversity for transmit diversity is particularly advantageous in order to be able to arrange the antenna radiators spatially close to one another without disturbing the omnidirectional transmitting in this way.

It is suitable to resort to switching diversity or maximum-ratio combining for receive diversity in order to achieve reliable omnidirectional reception.

It is advantageous for the installation of the antenna arrangement on or in a vehicle to accommodate the antenna radiators, together with antennas for other purposes such as, for example, GPS or mobile radio, in a housing. This minimizes the space requirement of a housing for antennas.

To reduce the space requirement of the antenna radiators for a vehicle further, installation in one or more window panes of the vehicle is of advantage.

A method corresponding to the subordinate method claim offers corresponding advantages.

### BRIEF DESCRIPTION OF THE DRAWINGS

Exemplary embodiments of the invention are shown in the drawings and explained in greater detail in the subsequent description.

FIG. 1 shows an exemplary embodiment of an antenna arrangement according to the invention.

FIG. 2 shows omnidirectional patterns of individual antenna radiators and FIG. 3 shows the combination of the two unidirectional patterns by means of diversity with respect to an almost omnidirectional pattern.

FIG. 4 shows an exemplary embodiment of the antenna arrangement directly on the vehicle.

### EMBODIMENTS OF THE INVENTION

The embodiments describe antenna radiators which are suitable for a frequency or a number of frequencies within the band from 0.5 GHz to 11 GHz.

In this arrangement antenna radiators can be suitable for a frequency of 5.9 GHz in one embodiment since the

ETSI standard provides communication between vehicles at this frequency. In another embodiment, a use of other frequencies with correspondingly adapted antennas is possible.

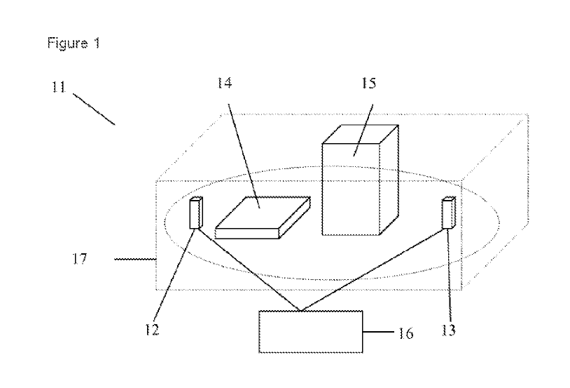

FIG. 1 shows an antenna arrangement 11 for an antenna housing of a vehicle. A first antenna radiator 12 and a second antenna radiator 13 are positioned at both ends of a housing 17. In this arrangement, the first antenna radiator 12 is arranged at the front in the housing 17 in the direction of the vehicle front and the second antenna radiator 13 is arranged at the rear in the housing 17 in the direction of the rear of the vehicle. The first antenna radiator 12 has a preferred direction aligned toward the front. The second antenna radiator 13 has a preferred direction aligned toward the rear. The housing 17 has, for example, a size of 5 cm to 20 cm in length, 1 cm to 10 cm in width and 1 cm to 5 cm in height. An antenna radiator 12 or 13, respectively, can be, for example, 1 cm to 2 cm high or constructed as λ/4 monopol. In this arrangement, the space between the first antenna radiator 12 and the second antenna radiator 13 is, for example, 5 cm to 20 cm. The space between the first antenna radiator 12 and the second antenna radiator 13 should be selected as the maximum possible space allowed by an installation in the housing. This enables a diversity system 16 which controls the first antenna radiator 12 and second antenna radiator 13 to receive a signal which is an uncorrelated as possible.

In a further embodiment, the arrangement of the antenna radiators 12 and 13 can be selected in such a manner that the housing 17 is smaller at the front and rear than in the center and a GPS antenna 14 and a mobile radio antenna 15 are arranged in the center of the housing.

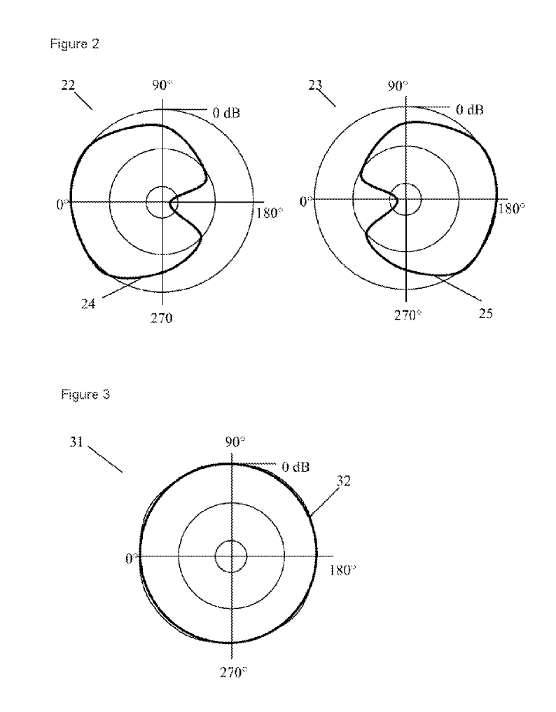

FIG. 2 shows a first pattern 22 of the first, front antenna radiator 12 and a second pattern 23 of the second, rear antenna radiator 13. The first pattern 22 represents the preferred direction of the first antenna radiator 12. The preferred direction in the first pattern 22 points in the direction of the vehicle front. The second pattern 23 represents the preferred direction of the second antenna radiator 13. The preferred direction in the second pattern 23 points in the direction of the vehicle rear.

The diversity system 16 controls transmit and receive diversity. FIG. 3 shows a third pattern 31 which is achieved as a result of the diversity system 16 from the combination of the first pattern 22 and the second pattern 23 or the first antenna radiator 12 and the second antenna radiator 13, respectively.

The first pattern 22 shows a top view of the intensity of the energy radiation of a first electromagnetic field 24 of the first antenna radiator 12 where the first antenna radiator 12 is positioned at the center of the first pattern 22. The first pattern 22 has a characteristic pattern in the form of a kidney aligned to 0°. Similarly, the second pattern 23 shows a top view of the intensity of the energy radiation of a second electromagnetic field 25 of the second antenna radiator 13 where the second antenna radiator 13 is positioned at the center of the second pattern 23. The second pattern 23 has a characteristic pattern in the form of a kidney aligned to 180°. The alignment of the first antenna radiator 12 and the alignment of the second antenna radiator 13 enclose in each case an angle to an amount of 180°. The alignments of the antenna radiators 12 and 13 have been selected in such a manner that the amounts of the angles between the alignments are of equal magnitude. By using and combining the first antenna radiator 12 and the second antenna radiator 13, a diversity method thus achieves the third pattern 31 having an almost omnidirectional characteristic 32.

In one embodiment, a receive diversity can be implemented by means of switching diversity. Switching diversity uses only the antenna radiator which currently offers the greater received power for reception.

A further embodiment can use maximum-ratio combining for receive diversity. In this arrangement, both antenna radiators are used and the signals of the antennas are added weighted by means of anolog or digital signal processing.

Transmit diversity can take place by means of delay diversity or cyclic delay diversity. In this context, the same transmit signal is radiated via both antenna radiators and one of the two signals is delayed with respect to the other signal. OFDM (Orthogonal Frequency Division Multiplex) systems can receive the signals at the receiver end.

In another embodiment, a multiple-input-multiple-output system is used instead of the diversity system 16.

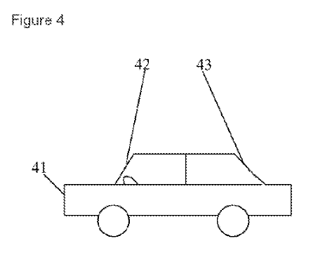

FIG. 4 shows an arrangement of a first antenna radiator 42 and a second antenna radiator 43 in a further embodiment. The first antenna radiator 42, having a preferred direction to the front of the vehicle and the second antenna radiator 43 having a preferred direction to the rear of the vehicle are mounted directly on the vehicle 41. The preferred direction of the first antenna radiator 42 is selected in the direction of the front of the vehicle away from the vehicle 41 since the vehicle 41 shades the alignment toward the rear. Similarly, the preferred direction of the second antenna radiator 43 is toward the rear since the vehicle 41 shades the alignment toward the front. The patterns are combined again by means of a diversity or multiple-input-multiple-output system.

In a further embodiment, the antenna radiators are aligned in such a manner that their preferred direction extends in parallel with the plane on which the vehicle is located.

A further embodiment has the antenna radiators aligned in such a manner that their preferred directions are diametrically opposed to one another, i.e. there is an angle of 180° between the preferred directions.

A further embodiment uses more than only two antenna radiators.

In a further embodiment having more than two antenna radiators, the antenna radiators are aligned in such a manner that their preferred directions extend in parallel with the plane on which the vehicle is located.

A further embodiment has more than two antenna radiators aligned in such a manner that their preferred directions have equally large angles between the preferred directions.

1. An antenna arrangement for vehicle-vehicle communication, comprising:
at least two antenna radiators each having a unidirectional pattern, the at least two antenna radiators being positioned in such a manner that a combination of the unidirectional patterns of the antenna radiators generates a largely omnidirectional pattern by a method for transmitting and/or receiving.

2. The antenna arrangement as claimed in claim 1, wherein the at least two antenna radiators are configured for a frequency of between 0.5 GHz and 11 GHz.

3. The antenna arrangement as claimed in claim 1, wherein diversity methods or multiple-input-multiple-output methods are used as methods for transmitting and/or receiving.

4. The antenna arrangement as claimed in claim 1, wherein the method for transmitting is implemented by means of delay diversity or cyclic delay diversity.

5. The antenna arrangement as claimed in claim 1, wherein the the method for receiving is implemented by switching diversity or maximum-ratio combining.

6. The antenna arrangement as claimed in claim 1, wherein the antenna radiators, together with at least one further antenna configured for other radio systems, are installed in a housing.

7. The antenna arrangement as claimed in claim 1, wherein the antenna radiators are integrated in one or more window panes of a vehicle.

8. A method for communication between vehicles, comprising:
positioning at least two antenna radiators each having a unidirectional pattern in such a manner that a combination of their unidirectional patterns generates a largely omnidirectional pattern, wherein the largely omnidirectional pattern is generated by a method for transmitting and receiving.

9. The method as claimed in claim 8, wherein the at least two antenna radiators are configured for a frequency of between 0.5 GHz and 11 GHz.

10. The method as claimed in claim 8, wherein diversity methods or multiple-input-multiple-output methods are used as methods for transmitting and/or receiving.

11. The method as claimed in claim 8, wherein delay diversity or cyclic delay diversity is used for transmitting.

12. The method as claimed in claim 8, wherein switching diversity or maximum-ratio combining is used for receiving.

13. The antenna arrangement as claimed in claim 2, wherein the at least two antenna radiators are configured for a frequency of 5.9 GHz.

14. The method as claimed in claim 9, wherein the at least two antenna radiators are configured for a frequency of 5.9 GHz.
